(19) United States
(12) Patent Application Publication
(10) Pub. No.: US 2015/0143538 A1
(43) Pub. Date: May 21, 2015

(54) Portable Eye-Controlled Device, Verification Device and Method, Computer Readable Recording Medium and Computer Program Product

(71) Applicant: UTECHZONE CO., LTD., New Taipei City (TW)

(72) Inventor: Chia-Chun Tsou, New Taipei City (TW)

(21) Appl. No.: 14/338,954

(22) Filed: Jul. 23, 2014

(30) Foreign Application Priority Data
Nov. 15, 2013 (TW) 102141635

(51) Int. Cl. G06F 21/32; H04L 29/06; G06K 9/00

(52) U.S. Cl. CPC G06F 21/32; G06K 9/00617; H04L 63/083
USPC 726/28

(57) ABSTRACT

The present invention provides a portable eye-controlled device, which is coupled to a security apparatus and is adapted to verify a user's authority, the portable eye-controlled device comprising: a displaying unit for displaying a password menu to perform a password entering procedure; an image-capturing unit for capturing an eye image of the user's eye; and a processing unit for analyzing the eye image to obtain an input string from the user and compare the input string with a predetermined safe password, wherein, processing unit generates a verification message to the security apparatus when the safe password matches the input string.

### BACKGROUND OF THE INVENTION

1.Technical Field

The present invention relates to verification devices and methods thereof, and more particularly, to a verification device and method operable by a portable eye-controlled device.

2. Description of Related Art

Commercially-available safes and security apparatuses are protected mostly by password locks. Password locks have advantages, such as many possible combinations, absence of keyholes, and thus a low chance of defeating the password locks. The password locks fall into two categories, namely mechanical password locks and electronic password locks. The mechanical password locks are advantageous in that they require no power supply or battery and are mechanized fully enough to survive whatever adverse surroundings. The electronic password locks are advantageous in that they work quickly and their passwords are easy to change. However, being equipped with dials or keyboards for entering passwords, the mechanical password locks and the electronic password locks are likely targets of a sniffing system and a peek, not to mention that fingerprints are likely to be left on the dials and keyboards. As a result, the prior art poses a risk of leaking the passwords of the mechanical password locks and the electronic password locks.

Furthermore, the conventional mechanical and electronic password locks are disadvantageous in that their passwords are inadequately concealable, because their passwords are displayed on a screen upon entry thereto and thus are likely targets of a peek and a sniffing system, not to mention that a conventional verification device is seldom as high as a user's body height. The user may be too short or tall to reach the conventional verification device and thus finds it inconvenient to operate. For example, in the latter scenario, the user has to squat in order to perform password-entering with the conventional verification device.

### BRIEF SUMMARY OF THE INVENTION

It is an objective of the present invention to increase concealability of passwords of conventional password locks and render the conventional password locks easy to operate regardless of differences in body height between users.

In order to solve the above mentioned problems, the present invention provides a portable eye-controlled device, which is coupled to a security apparatus and is adapted to verify a user's authority, the portable eye-controlled device comprising: a displaying unit for displaying a password menu to perform a password entering procedure; an image-capturing unit for capturing an eye image of the user's eye; and a processing unit for analyzing the eye image to obtain an input string from the user and compare the input string with a predetermined safe password, wherein, the processing unit generates a verification message to the security apparatus when the safe password matches the input string.

Preferably, the portable eye-controlled device further comprises a casing having a window for the user to look at, wherein the user holds the casing and performs the password entering procedure through the window; and a reflecting minor disposed in the casing to reflect an image of the password menu, such that the user can look at the password menu through the window.

Preferably, the displaying unit is disposed in the casing, and the image of the password menu is reflected by the reflecting minor and is visible at the window, wherein the image-capturing unit disposed in the casing captures the eye image while the user is looking at the password menu through the window.

Preferably, the processing unit analyzes iris features of the eye image to generate an iris information and compare the iris information with a predetermined authority information.

Preferably, the processing unit comprises: a data storing module for storing the eye image, at least one said safe password, and the authority information; and an image analyzing module for analyzing the eye image to confirm the user's eye movement information and the user's authority.

Preferably, the image analyzing module comprises an eye movement analyzing module and an iris recognizing module, the eye movement analyzing module analyzing the user's eye movement information according to the eye image so as to confirm a plurality of target points on the password menu where the user looks at and obtain the input string, and the iris recognizing module analyzing the iris information according to the eye image so as to confirm whether the user is an authorized client.

Preferably, the eyepiece device further comprises a transmission line for connecting the portable eye-controlled device and the security apparatus.

Preferably, the portable eye-controlled device further comprises a wireless communication unit for transmitting information between the portable eye-controlled device and the security apparatus by wireless communication selected from one of short-distance wireless communication, radio frequency identification (RFID), Bluetooth, and Wi-Fi.

Preferably, the portable eye-controlled device further comprises a light source for irradiating the user's eye to form a light spot on the user's eyeball, the light spot serving as a reference feature when the processing unit analyzes the eye image.

Another aspect of the present invention is to provide a verification device equipped with a portable eye-controlled device, coupled to a security apparatus, and configured to verify a user's authority, the verification device comprising: a portable eye-controlled device held in the user's hands to cover the user's eye so as to perform a password entering procedure, wherein the portable eye-controlled device has a displaying unit for displaying a password menu and an image-capturing unit for capturing an eye image of the user's eye; and a processing device coupled to the portable eye-controlled device to receive and analyze the eye image so as to obtain an input string from the user and compare the input string with a predetermined safe password, wherein the processing device compares the input string with the predetermined safe password, and the processing device generates a verification instruction to the security apparatus upon determination that the safe password matches the input string.

Preferably, the portable eye-controlled device further comprises: a casing having a window for the user to look at, wherein the user holds the casing and performs the password entering procedure through the window; and a reflecting minor disposed in the casing to reflect an image of the password menu, such that the user can look at the password menu through the window.

Preferably, the displaying unit is disposed in the casing, wherein the image of the password menu is reflected by the reflecting minor and is visible at the window, wherein the image-capturing unit disposed in the casing to capture the eye image while the user is looking at the password menu through the window.

Preferably, the processing device analyzes iris features of the eye image to generate an iris information and compare the iris information with a predetermined authority information.

Preferably, the processing device comprises: a data storing module for storing the eye image, at least one said safe password, and the authority information; and an image analyzing module for analyzing the eye image to confirm the user's eye movement information and the user's authority.

Preferably, the image analyzing module comprises an eye movement analyzing module and an iris recognizing module, the eye movement analyzing module analyzing the eye movement information according to the eye image so as to confirm a plurality of target points on the password menu where the user looks at, and the iris recognizing module analyzing the iris information according to the eye image so as to confirm whether the user is an authorized client.

Preferably, the verification device further comprises a transmission line for connecting the portable eye-controlled device and the processing device.

Preferably, the portable eye-controlled device and the processing device each comprise a wireless communication unit for transmitting information between the portable eye-controlled device and the processing device by wireless communication selected from one of short-distance wireless communication, radio frequency identification (RFID), Bluetooth, and Wi-Fi.

Preferably, the verification device further comprises a light source for irradiating the user's eye to form a light spot on the user's eyeball, the light spot serving as a reference feature when the processing device analyzes the eye image.

Preferably, the security apparatus being one of a lock, a safe, an access control system, and an authority verifying device.

Still another aspect of the present invention is to provide a password entering method operable by a portable eye-controlled device, comprising the steps of: providing the portable eye-controlled device for covering a user's eye to perform a password entering procedure; capturing the user's eye image by an image-capturing unit in the portable eye-controlled device and displaying a password menu on a displaying unit in the portable eye-controlled device; capturing the user's eye image by the image-capturing unit in the portable eye-controlled device; performing an image analyzing step to analyze the eye image and obtain an input string; comparing the input string with a predetermined safe password; and generating a verification message to a security apparatus when the safe password matches the input string.

Preferably, the image analyzing step comprises: irradiating the user's eye to form a light spot on the user's eye, the light spot serving as a reference feature in the image analyzing step, so as to obtain the user's eye movement information; and determining, according to the eye movement information, a plurality of target points on the password menu where the user looks at.

Preferably, the password entering method further comprises analyzing iris features of the eye image to generate an iris information and compare the iris information with a predetermined authority information.

Another aspect of the present invention is to provide a computer readable medium, which is loadable and executable by a computer to execute the method of the present invention.

Another aspect of the present invention is to provide a computer program product, which is loadable and executable by a computer to execute the method of the present invention.

Implementation of the present invention at least involves the following advantages:

1. A portable eye-controlled device of the present invention is separable and thus easy to operate regardless of differences in body height between users.

2. The portable eye-controlled device of the present invention functions as a cover for preventing noise and overexposure which might otherwise be caused by an external light source during a test.

### BRIEF DESCRIPTION OF THE SEVERAL VIEWS OF THE DRAWINGS

Objectives, features, and advantages of the present invention are hereunder illustrated with specific embodiments in conjunction with drawings, in which:

FIG. 1 is a block diagram of a portable eye-controlled device of the present invention;

FIG. 2 is a block diagram of a verification device of the present invention;

FIG. 3 is a schematic perspective view of the verification device according to the first embodiment of the present invention;

FIG. 4 is a schematic view (1) of the operation of a portable eye-controlled device according to the first embodiment of the present invention;

FIG. 5 is a schematic view (2) of the operation of the portable eye-controlled device according to the first embodiment of the present invention;

FIG. 6 is a schematic cross-sectional view of the portable eye-controlled device of the present invention;

FIG. 7 is a schematic view of imaging of a user's eye of the present invention;

FIG. 8 is a schematic view of a mobile device of the present invention;

FIG. 9 is a schematic view (1) of the operation of the mobile device according to the second embodiment of the present invention;

FIG. 10 is a schematic view (2) of the operation of the mobile device according to the second embodiment of the present invention;

FIG. 11 is a schematic view of a password menu of the present invention; and

FIG. 12 is a flow chart of an ocularly-driven password entering method of the present invention.

For illustrative purposes, the drawings are not drawn to scale, but are drawn exaggeratedly as needed; hence, the drawings and their proportions are not restrictive of the present invention.

### DETAILED DESCRIPTION OF THE INVENTION

The present invention provides a portable eye-controlled device and a verification device which are operable in conjunction with a security apparatus to effectuate user verification. The security apparatus of the present invention comes in various forms. Specifically speaking, the security apparatus is a typical lock or safe, an access control system of a building, dormitory or household, or an identity verifying device for use in verification of transactions conducted with a typical ATM system or Web-based ATM. However, the aforesaid applications are the preferred embodiments of the present invention but are not restrictive of the present invention.

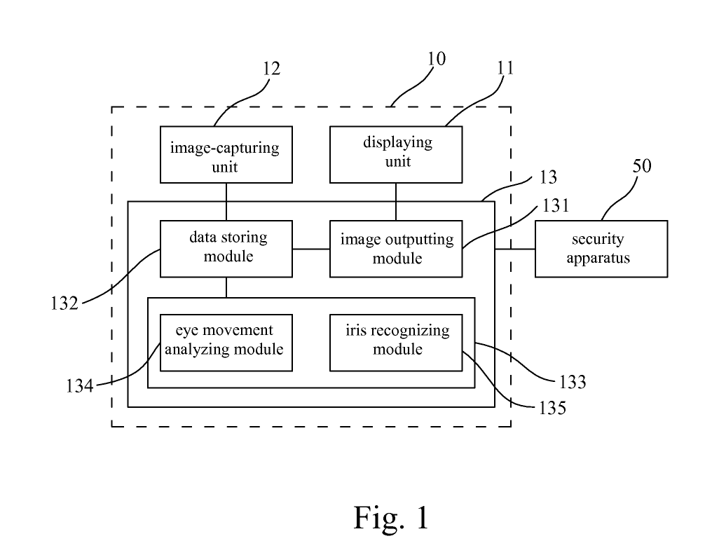

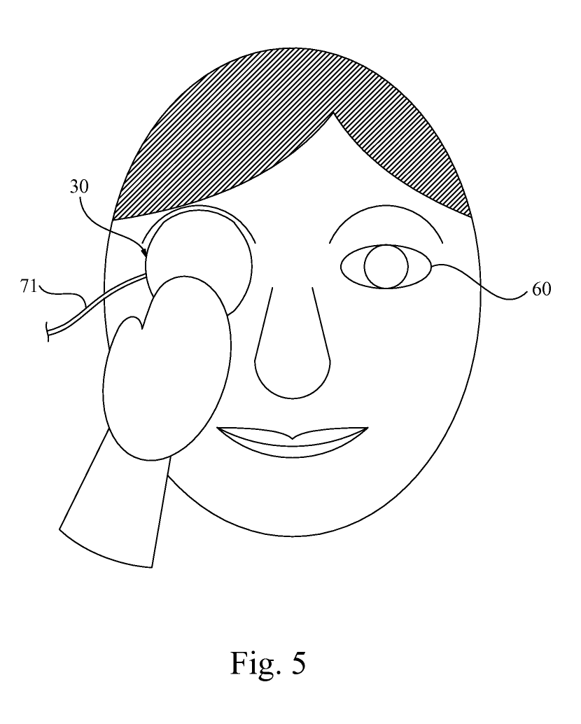

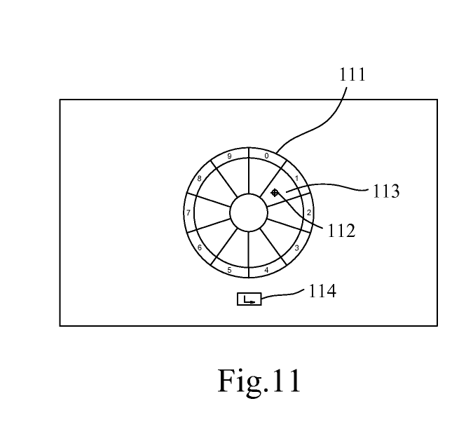

Referring to FIG. 1, there is shown a block diagram of a portable eye-controlled device 10 of the present invention. In this embodiment, the portable eye-controlled device 10 of the present invention is connectable to a security apparatus 50 to verify a user's authority. The portable eye-controlled device 10 comprises a displaying unit 11, an image-capturing unit 12, and a processing unit 13. The displaying unit 11 displays a password menu 111 (as shown in FIG. 11) performing a password entering procedure. The image-capturing unit 12 takes a picture of a user's eye 60 (as shown in FIG. 5) to capture eye image. The processing unit 13 analyzes the eye image to obtain an input string from the user and then compares the input string with a predetermined safe password. If the safe password matches the input string, the processing unit 13 will generate a verification message to the security apparatus 50 to open a lock.

The processing unit 13 comprises an image outputting module 131, a data storing module 132, and an image analyzing module 133. The data storing module 132 stores the eye image and at least one said safe password, and the authority information. The image outputting module 131 is capable of image outputting and thus displays the password menu 111 pre-stored in the data storing module 132 on the displaying unit 11. The image analyzing module 133 comprises an eye movement analyzing module 134 and an iris recognizing module 135. The eye movement analyzing module 134 analyzes the eye movement information according to the eye image, so as to confirm a plurality of target points on the password menu 111 where the user looks at. The iris analyzing module 135 analyzes the iris information according to the eye image, so as to confirm whether the user is an authorized client.

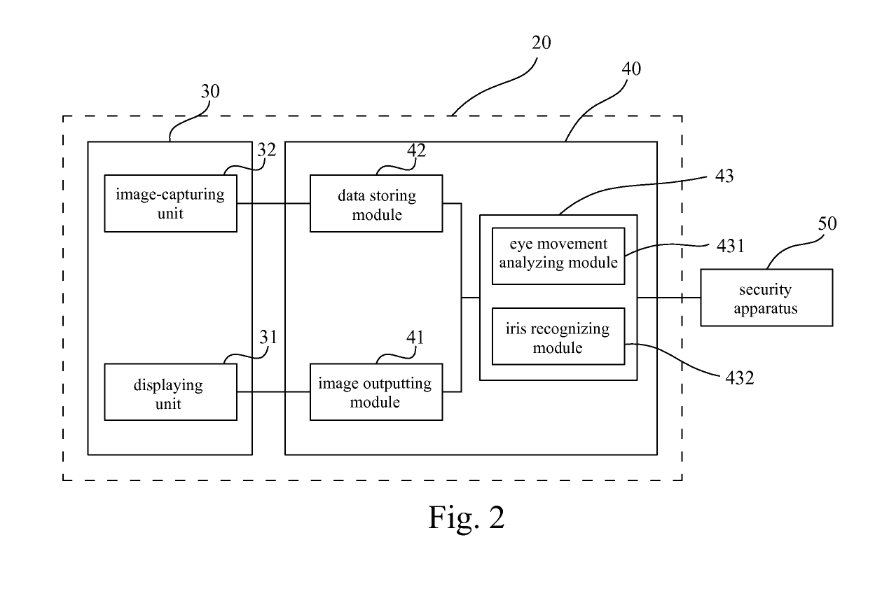

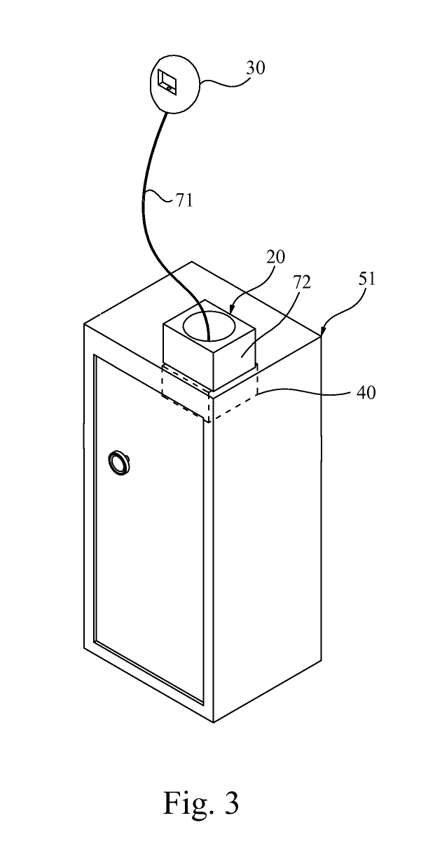

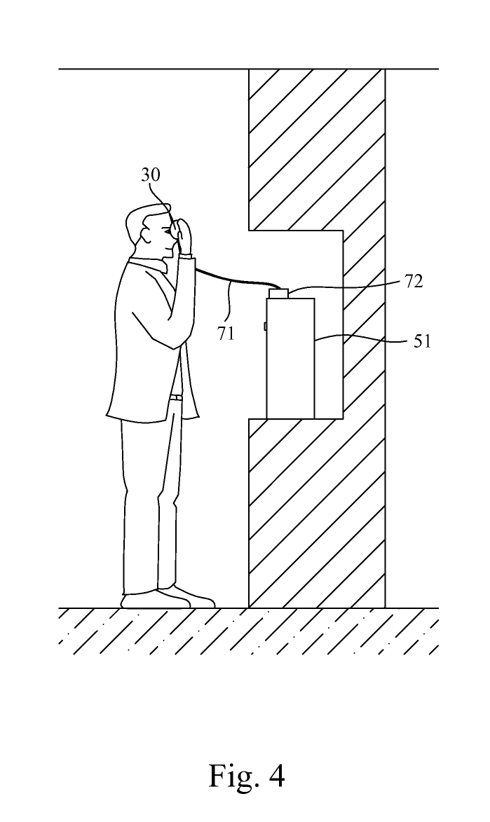

Referring to FIG. 2, there is shown a block diagram of a verification device 20 of the present invention. The verification device 20 of the present invention essentially comprises a portable eye-controlled device 30 and a processing device 40 in signal connection with the portable eye-controlled device 30 and the security apparatus 50. The portable eye-controlled device 30 can be held in the user's hands to cover the user's eye 60, so as to perform a password entering procedure (as shown in FIG. 3 and FIG. 4). The portable eye-controlled device 30 essentially comprises a displaying unit 31 for displaying the password menu 111 and an image-capturing unit 32 for taking pictures of the user's eye 60 so as to capture eye image. The processing device 40 receives and analyzes the eye image captured by the image-capturing unit 32 so as to obtain an input string entered by the user through eye movement and compare the input string with a predetermined safe password. If the processing device 40 confirms that the input string matches the predetermined safe password, the processing device 40 will generate a verification instruction to the security apparatus 50 to open a lock.

The processing device 40 comprises an image outputting module 41, a data storing module 42, and an image analyzing module 43. The data storing module 42 stores the eye image, at least one said safe password, and the authority information. The image analyzing module 43 comprises an eye movement analyzing module 431 and an iris recognizing module 432. The eye movement analyzing module 431 analyzes the eye movement information according to the eye image, so as to confirm a plurality of target points on the password menu 111 where the user looks at. The iris recognizing module 432 analyzes the iris information according to the eye image, so as to confirm whether the user is an authorized client.

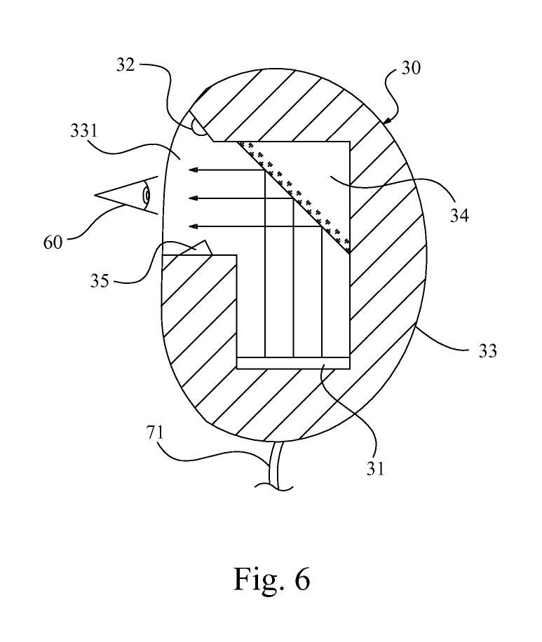

Referring to FIG. 3 through FIG. 6, there are shown schematic views of the verification device for use with a safe according to an embodiment of the present invention. As shown in the diagrams, in this embodiment, the verification device operates in conjunction with a safe 51. Although the description of this embodiment of the present invention is centered on the verification device 20, the present invention can be based on the portable eye-controlled device 10 when it comes to an actual product. In this embodiment, the portable eye-controlled device 30 can be held in the user's hands to cover the user's eye 60. The portable eye-controlled device 30 and the processing device 40 are connected by a transmission line 71. A line collecting box 72 is positioned concurrently on one side of the processing device 40. After the user has finished the password entering process, the line collecting box 72 collects the transmission line 71 by means of a winder (not shown), such that the portable eye-controlled device 30 restores its initial position. In another preferred embodiment, the portable eye-controlled device 30 and the processing device 40 each have a wireless communication unit for connecting the portable eye-controlled device and the processing device by means of wireless communication, such as short-distance wireless communication, radio frequency identification (RFID), Bluetooth, or Wi-Fi, but the present invention is not limited thereto. FIG. 6 illustrates the internal structure of the portable eye-controlled device 30. The portable eye-controlled device 30 essentially comprises a casing 33, a reflecting minor 34, a light source 35, and the displaying unit 31 and the image-capturing unit 32 which are disposed in the casing 33. The casing 33 has a window 331 for the user to look at. The user performs a password entering procedure through the window 331 while holding the casing 33 by hand. The reflecting minor 34 is disposed between the displaying unit 31 and the window 331. The reflecting minor 34 reflects an image of the password menu 111 on the displaying unit 31, such that the user can look at the password menu 111 through the window 331. The image-capturing unit 32 and the light source 35 are positioned in the vicinity of the window 331. The image-capturing unit 32 takes pictures of the user's eye 60 to capture eye image while the user is looking at the password menu 111 through the window 331.

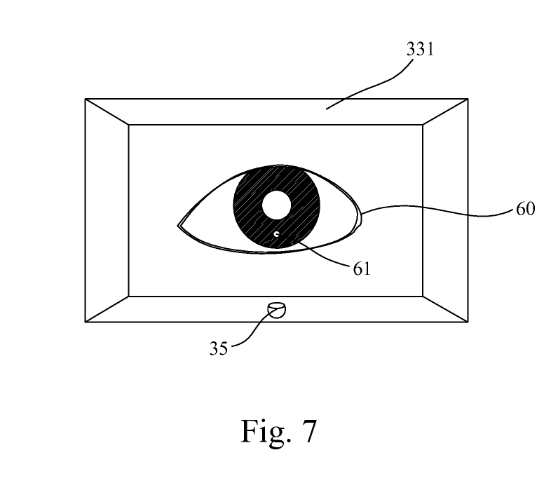

FIG. 7 is a schematic view of imaging of a user's eye of the present invention and relates to light spot technology. Eye image not only lack any readily recognizable reference point but also carry excessive noise because of an inadequate light source or an untidy ambient light source. To accurately determine the direction in which the user's eye 60 looks at, the light source 35 is positioned in the vicinity of the window 331. As soon as the user's eye 60 approaches the window 331, the light source 35 turns on and irradiates the user's eye 60 so as to form a light spot 61 on the user's eyeball. The light spot serves as a reference feature when the eye movement analyzing module 431 analyzes, so as to confirm the user's eye movement information.

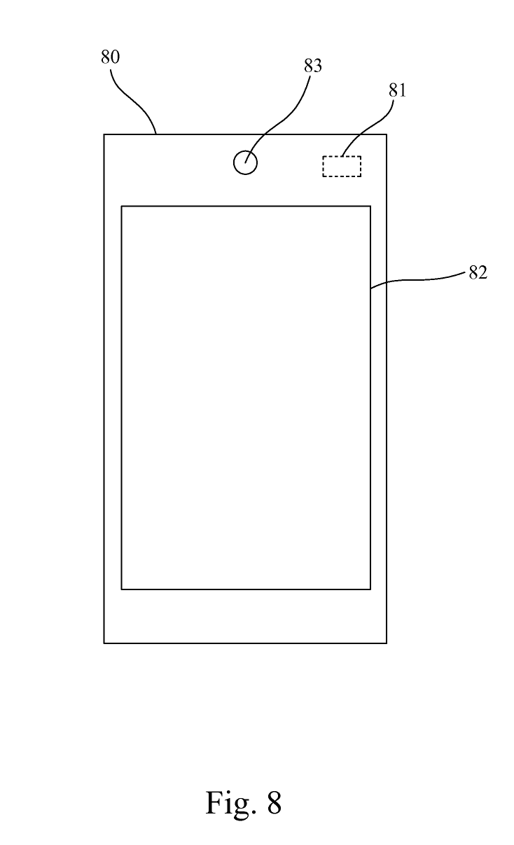

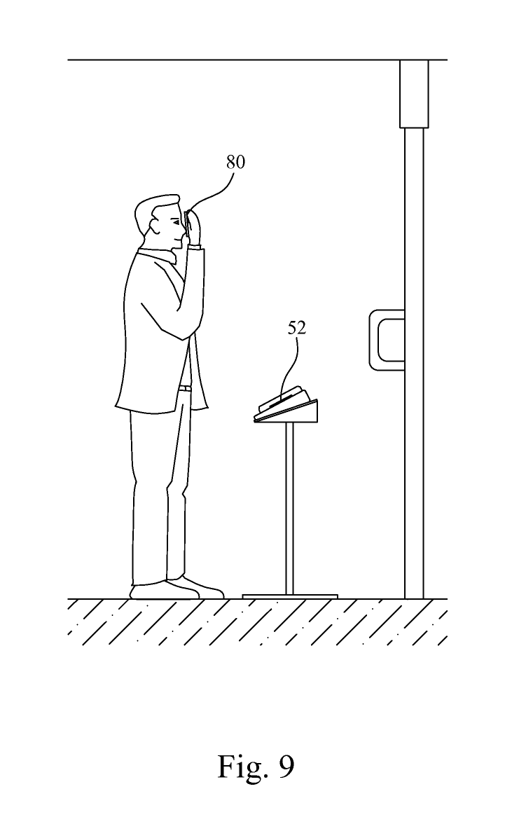

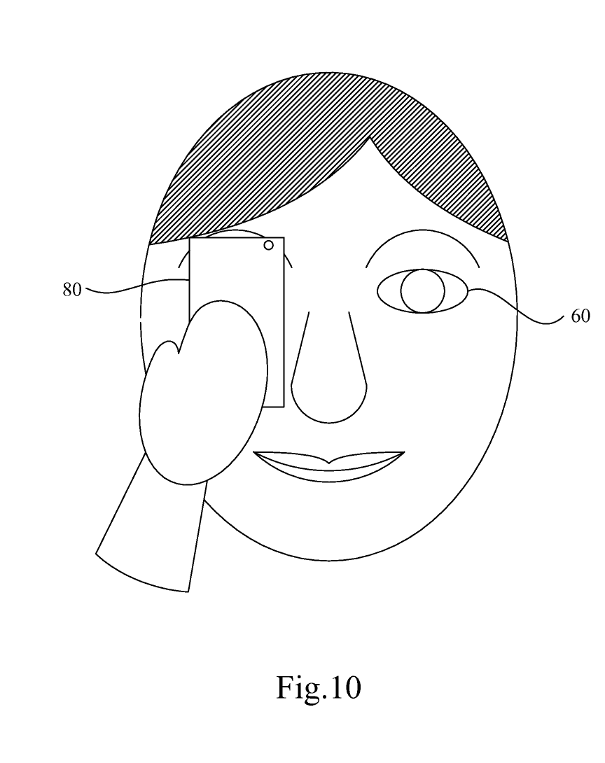

Referring to FIG. 8 through FIG. 10, there are shown schematic views of the portable eye-controlled device 10 according to another embodiment of the present invention. Although this embodiment illustrates one of the applications of the portable eye-controlled device 10 of the present invention, the present invention can be based on the verification device 20 when it comes to an actual product. The portable eye-controlled device 10 is provided in the form of a portable mobile device 80 and is for use in the control of an access control system 52 (the security apparatus 50). For example, the user installs a program in the mobile device 80, wherein the program is applicable to the access control system 52. As soon as the user starts the program with the mobile device 80, a wireless communication unit 81 in the mobile device 80 gets connected to the access control system 52, and then a password menu 111 is displayed on a screen 82 (i.e., the displaying unit 11) of the mobile device 80; meanwhile, a front lens 83 (i.e., the image-capturing unit 12) of the mobile device 80 captures images of the user's eye 60, so as to confirm a plurality of target points on the password menu 111 where the user looks at, such that the input string is determined according to the direction in which the user looks at.

For more details of the password menu 111, study FIG. 11. In this embodiment, the password menu 111 is ring-shaped, and the user controls a cursor 112 in entering a password according to what the user looks at. For example, to enter the number 1 shown on the password menu 111, the user moves the cursor 112 to a box 113 adjacent to the number 1 by means of eye movement and allows the cursor 112 to stay in the box 113 for a while in order to confirm the input string. When the password entering process is done, the user moves the cursor 112 to an enter button 114 below the password menu 111 so as to confirm that the password has been entered.

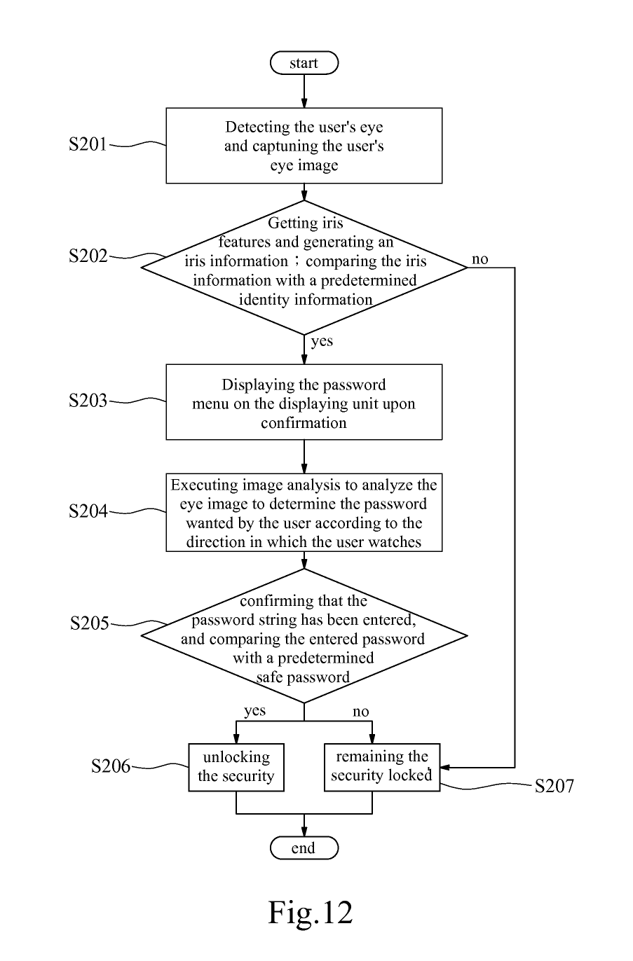

Referring to FIG. 12, there is shown a flow chart of an ocularly-driven password entering method of the present invention. The process flow of the entering of the ocularly-driven password is described below. First, the user holds the portable eye-controlled device 10 and covers the user's eye 60 with the portable eye-controlled device 10. At this point in time, the portable eye-controlled device 10 detects the user's eye 60, and an image-capturing unit 12 in the portable eye-controlled device 10 captures the user's eye image (step S201). An image analyzing step is performed on iris features of the eye image to generate an iris information and then compare the iris information with a predetermined authority information (step S202). Step S202 is optional; hence, step S202 can be omitted as needed, such that step S201 is followed immediately by step S203. Upon confirmation that the iris information matches the predetermined authority information, the password menu 111 is created and displayed on the displaying unit 11 in the portable eye-controlled device 10 (step S203). Afterward, the image analyzing step continues analyzing the eye image to determine the password wanted by the user according to the direction in which the user looks at, so as to obtain an input string (step S204). The image analyzing step comprises: turning on the light source 35 to irradiate the user's eye 60 so as to form a light spot 61 on the user's eye 60, such that the light spot 61 serves as a reference feature in the image analyzing step to thereby obtain the user's eye movement information; and determining a plurality of target points on the password menu 111 where the user looks at according to the eye movement information. Afterward, as soon as the user presses the enter button 114 to confirm that the input string has been entered, comparison of the input string with a predetermined safe password begins (step S205). Upon determination that the safe password matches the input string, a verification message is generated to a security apparatus 50 (step S206). In step S202 or step S205, if it is determined that the iris information does not match a predetermined authority information or that the input string does not match a predetermined safe password, security locking will continue (step S207).

The process flow of the method of the present invention can also be carried out with software, such as a computer readable medium stored in a compact disk, a hard disk drive, or a semiconductor memory device, or a computer program product transmitted by a network and installed on an electronic device so as to be accessible by the electronic device. Specifically speaking, the electronic device is a safe, a mobile device, a building access control system, or a security system, which is equipped with an electrically-driven lock, or a similar electronic device or apparatus.

In conclusion, the present invention provides a portable eye-controlled device easy to operate regardless of differences in body height between users. Furthermore, the portable eye-controlled device of the present invention covers the user's eye efficiently to prevent noise and overexposure which might otherwise be caused by an external light source during a test.

While the present invention has been described in connection with certain exemplary embodiments, it is to be understood that the invention is not limited to the disclosed embodiments, but, on the contrary, is intended to cover various modificaions and equivalent arrangements included within the spirit and scope of the appended claims, and equivalents thereof.

What is claimed is:

1. A portable eye-controlled device, which is coupled to a security apparatus and is adapted to verify a user's authority, the device comprising:
a displaying unit for displaying a password menu to perform a password entering procedure;
an image-capturing unit for capturing an eye image of the user's eye; and
a processing unit for analyzing the eye image to obtain an input string from the user and compare the input string with a predetermined safe password,
wherein the processing unit generates a verification message to the security apparatus when the safe password matches the input string.

2. The portable eye-controlled device of claim 1, further comprising:
a casing having a window for the user to look at, wherein the user holds the casing and performs the password entering procedure through the window; and
a reflecting mirror disposed in the casing to reflect an image of the password menu, such that the user can look at the password menu through the window.

3. The portable eye-controlled device of claim 2, wherein the displaying unit is disposed in the casing, and the image of the password menu is reflected by the reflecting mirror and is visible at the window, wherein the image-capturing unit disposed in the casing captures the eye image while the user is looking at the password menu through the window.

4. The portable eye-controlled device of claim 1, wherein the processing unit analyzes iris features of the eye image to generate an iris information and compare the iris information with a predetermined authority information.

5. The portable eye-controlled device of claim 4, wherein the processing unit comprises:
a data storing module for storing the eye image, at least one said safe password, and the authority information; and
an image analyzing module for analyzing the eye image to confirm the user's eye movement information and the user's authority.

6. The portable eye-controlled device of claim 5, wherein the image analyzing module comprises an eye movement analyzing module and an iris recognizing module, the eye movement analyzing module analyzing the user's eye movement information according to the eye image so as to confirm a plurality of target points on the password menu where the user looks at and obtain the input string, and the iris recognizing module analyzing the iris information according to the eye image so as to confirm whether the user is an authorized client.

7. The portable eye-controlled device of claim 1, further comprising a transmission line for connecting the portable eye-controlled device and the security apparatus.

8. The portable eye-controlled device of claim 1, further comprising a wireless communication unit for transmitting information between the portable eye-controlled device and the security apparatus by wireless communication selected from one of short-distance wireless communication, radio frequency identification (RFID), Bluetooth, and Wi-Fi.

9. The portable eye-controlled device of claim 1, further comprising a light source for irradiating the user's eye to form a light spot on the user's eyeball, the light spot serving as a reference feature when the processing unit analyzes the eye image.

10. A verification device coupled to a security apparatus and configured to verify a user's authority, the verification device comprising:
an portable eye-controlled device held in the user's hands to cover the user's eye so as to perform a password entering procedure, wherein the portable eye-controlled device has a displaying unit for displaying a password menu and an image-capturing unit for capturing an eye image of the user's eye; and
a processing device coupled to the portable eye-controlled device to receive and analyze the eye image so as to obtain an input string from the user and compare the input string with a predetermined safe password,
wherein the processing device compares the input string with the predetermined safe password, and the processing device generates a verification pass instruction to the security apparatus upon determination that the safe password matches the input string.

11. The verification device of claim 10, wherein the portable eye-controlled device further comprises:
a casing having a window for the user to look at, wherein the user holds the casing and performs the password entering procedure through the window; and
a reflecting mirror disposed in the casing to reflect an image of the password menu, such that the user can look at the password menu through the window.

12. The verification device of claim 11, wherein the displaying unit is disposed in the casing, wherein the image of the password menu is reflected by the reflecting minor and is visible at the window, wherein the image-capturing unit disposed in the casing captures the eye image while the user is looking at the password menu through the window.

13. The verification device of claim 10, wherein the processing device analyzes iris features of the eye image to generate an iris information and compare the iris information with a predetermined authority information.

14. The verification device of claim 13, wherein the processing device comprises:
a data storing module for storing the eye image, at least one said safe password, and the authority information; and
an image analyzing module for analyzing the eye image to confirm the user's eye movement information and the user's authority.

15. The verification device of claim 14, wherein the image analyzing module comprises an eye movement analyzing module and an iris recognizing module, the eye movement analyzing module analyzing the eye movement information according to the eye image so as to confirm a plurality of target points on the password menu where the user looks at, and the iris recognizing module analyzing the iris information according to the eye image so as to confirm whether the user is an authorized client.

16. The verification device of claim 10, further comprising a transmission line for connecting the portable eye-controlled device and the processing device.

17. The verification device of claim 10, wherein the portable eye-controlled device and the processing device each comprise a wireless communication unit for transmitting information between the portable eye-controlled device and the processing device by wireless communication selected from one of short-distance wireless communication, radio frequency identification (RFID), Bluetooth, and Wi-Fi.

18. The verification device of claim 10, further comprising a light source for irradiating the user's eye to form a light spot on the user's eyeball, the light spot serving as a reference feature when the processing device analyzes the eye image.

19. A security apparatus for use with the portable eye-controlled device of claim 1, the security apparatus being one of a lock, a safe, an access control system, and an authority verifying device.

20. A security apparatus for use with the verification device of claim 10, the security apparatus being one of a lock, a safe, an access control system, and an authority verifying device.

21. A password entering method operable by a portable eye-controlled device, comprising the steps of:
providing the portable eye-controlled device for covering a user's eye to perform a password entering procedure;
capturing the user's eye image by an image-capturing unit in the portable eye-controlled device and displaying a password menu on a displaying unit in the portable eye-controlled device;
capturing the user's eye image by the image-capturing unit in the potable eye-controlled device;
performing an image analyzing step to analyze the eye image and obtain an input string;
comparing the input string with a predetermined safe password; and
generating a verification message to a security apparatus when the safe password matches the input string.

22. The password entering method of claim 21, wherein the image analyzing step comprises:
irradiating the user's eye to form a light spot on the user's eye, the light spot serving as a reference feature in the image analyzing step, so as to obtain the user's eye movement information; and
determining, according to the eye movement information, a plurality of target points on the password menu where the user looks at.

23. The password entering method of claim 21, further comprising analyzing iris features of the eye image to generate an iris information and compare the iris information with a predetermined authority information.

24. A computer readable medium, which is loadable and executable by a computer to execute the method of claim 21.

25. A computer program product, which is loadable and executable by a computer to execute the method of claim 21.
